(19) United States
(12) Patent Application Publication
(10) Pub. No.: US 2026/0112937 A1
(43) Pub. Date: Apr. 23, 2026

(54) STATOR UNIT, ELECTRIC MOTOR HAVING THE STATOR UNIT, AND AIR-CONDITIONING APPARATUS, REFRIGERATOR, AND ON-VEHICLE APPARATUS HAVING THE ELECTRIC MOTOR MOUNTED THERETO

(71) Applicant: AICHI ELECTRIC CO., LTD., Kasugai city (JP)

(72) Inventors: Nobuyuki NAGAI, Kasugai city (JP); Tomohiro OKUYAMA, Kasugai city (JP); Kenshin MATSUI, Kasugai city (JP); Masashi KUROKO, Kasugai city (JP); Shoji MANO, Kasugai city (JP)

(73) Assignee: AICHI ELECTRIC CO., LTD., Kasugai city (JP)

(21) Appl. No.: 19/365,381

(22) Filed: Oct. 22, 2025

(30) Foreign Application Priority Data
Oct. 22, 2024 (JP) 2024-185793

(51) Int. Cl. H02K 3/52; B60H 1/32; H02K 3/24

(52) U.S. Cl. CPC H02K 3/522; B60H 1/3222; H02K 3/24; H02K 2203/06; H02K 2203/12

(57) ABSTRACT

To provide a stator unit and the like that can ensure coil cooling efficiency. At least one cooling medium path between a plurality of coils is closed by a cluster block. However, since at least a part of a tube covering a neutral point is disposed between a bottom surface of the cluster block and the coil, the cooling medium path can be inhibited from being further closed by the tube. As a result, a cooling medium can easily pass through a lot of cooling medium paths, and thus, coil cooling efficiency can be ensured.

### BACKGROUND OF THE INVENTION

### 1. Field of the Invention

The present invention relates to a stator unit that can ensure coil cooling efficiency, an electric motor having the stator unit, and an air-conditioning apparatus, a refrigerator, and an on-vehicle apparatus having the electric motor mounted thereto.

### 2. Description of the Related Art

An electric compressor to be mounted to an air-conditioning apparatus, a refrigerator, an on-vehicle apparatus, or the like mainly includes a compressing portion for compressing a fluid, a three-phase alternating-current electric motor for driving the compressing portion, and a control circuit for performing drive control of the electric motor (International Publication No. WO2023/189893, Japanese Patent Application Laid-Open (kokai) No. 2018-157711). A stator of the three-phase AC electric motor includes a cylindrical stator core, an insulating cylindrical bobbin disposed on the axial end surface of the stator core, and a plurality of coils which form a three-phase coil, and which are wound around the stator core and the bobbin in a concentrated winding manner and are aligned in the circumferential direction of the stator core and the bobbin. A plurality of terminal-side lead wires are extracted from the respective coils, and a plurality of connection terminals disposed at the ends of the terminal-side lead wires, respectively, are connected to the control circuit. The connection terminals are stored in an insulating cluster block. Furthermore, a plurality of cooling medium paths are disposed between the plurality of the coils aligned in the circumferential direction so as to connect between both sides of the stator in the axial direction, and a cooling medium passes through the cooling medium paths and thus cools the coils.

According to International Publication No. WO2023/189893, a cluster block is brought into contact with the axial end surface of the bobbin on the side opposite to the stator core side in order to store the electric motor in a limited space in a housing of the electric compressor. Furthermore, as viewed in the axial direction, the cluster block is disposed so as to cover a part of portions between the plurality of coils, and a part of the cooling medium paths between the coils is thus closed by the cluster block.

According to Japanese Patent Application Laid-Open (kokai) No. 2018-157711, a neutral point is formed by connecting a plurality of neutral-point-side lead wires extracted from coils to each other, and the neutral point is covered by an insulating tube having a tubular bag-like shape in which the end is closed. The tube is inserted between the coils and thus fixed to a stator, but a part of the cooling medium paths between the coils is simultaneously closed. According to Japanese Patent Application Laid-Open (kokai) No. 2018-157711, since a space is formed to be wide in a housing of an electric compressor, the cluster block is distant from the bobbin in the axial direction and the cooling medium path is not closed by the cluster block.

According to Japanese Patent Application Laid-Open (kokai) No. 2018-157711, the cluster block is positioned so as to be distant from the tube in the circumferential direction. In Japanese Patent Application Laid-Open (kokai) No. 2018-157711, in a case where the cluster block is brought into contact with the bobbin as in International Publication No. WO2023/189893, the cooling medium paths disposed at different positions in the circumferential direction are closed by the cluster block and the tube, respectively. Therefore, a problem that coil cooling efficiency is degraded arises.

### SUMMARY OF THE INVENTION

The present invention has been made in order to solve the aforementioned problem, and an object of the present invention is to provide a stator unit that can ensure coil cooling efficiency, an electric motor having the stator unit, and an air-conditioning apparatus, a refrigerator, and an on-vehicle apparatus having the electric motor mounted thereto.

In order to attain the object, a stator unit of the present invention includes: a cylindrical stator disposed in an electric motor; and an insulating cluster block coming into contact with an end surface of the stator in an axial direction. The stator includes: a stator core having a plurality of tooth portions protruding inward from a yoke portion in a radial direction; an insulating bobbin disposed at an axial end surface of the stator core; a plurality of coils forming a three-phase coil, the plurality of coils being formed by a conductor wound around the bobbin and the respective tooth portions in a concentrated winding manner, the plurality of coils being aligned in a circumferential direction of the stator; a plurality of cooling medium paths each formed between the coils in the circumferential direction, and connected to both sides of the stator in the axial direction; a plurality of terminal-side lead wires each of which is continuous with one end of the conductor forming a corresponding one of the coils and is extracted from the corresponding one of the coils; a plurality of neutral-point-side lead wires each of which is continuous with another end of the conductor forming a corresponding one of the coils and is extracted from the corresponding one of the coils, the plurality of neutral-point-side lead wires being connected to each other to form a neutral point; and an insulating tube for covering the neutral point, the insulating tube having a tubular bag-like shape in which an end is closed. The cluster block is an insulating box-like member for storing a three-phase connection terminal disposed at an end of the plurality of terminal-side lead wires. A bottom surface of the cluster block comes into contact with an axial end surface of the bobbin on an opposite side to the stator core side so as to cover at least one of the cooling medium paths as viewed in the axial direction. At least a part of the tube is disposed between the bottom surface of the cluster block and the coils so as to overlap therewith as viewed in the axial direction.

In the stator unit according to a first aspect, the bottom surface of the cluster block comes into contact with the axial end surface of the bobbin on the opposite side to the stator core side. Therefore, as viewed in the axial direction, in a case where at least one cooling medium path between the plurality of coils is covered by the cluster block, the cooling medium path is closed by the cluster block. However, since at least a part of the tube covering the neutral point is disposed between the bottom surface of the cluster block and the coils so as to overlap therewith as viewed in the axial direction, the cooling medium path can be inhibited from being further closed by the tube. As a result, a cooling medium can easily pass through a lot of cooling medium paths, and thus, coil cooling efficiency can be ensured.

In the stator unit according to a second aspect, in addition to the effect exhibited by the stator unit according to the first aspect, the following effect is exhibited. In the circumferential direction of the bobbin, a direction in which the terminal-side lead wires exit from the cluster block is a first direction, and a direction opposite to the first direction is a second direction. The terminal-side lead wires are not densely disposed near the second direction side with respect to the cluster block as compared with near the first direction side, and the cooling medium path can thus be easily widened near the second direction side. An end of the closed tube faces in the second direction, and is disposed closer to the first direction side than an end portion of the cluster block in the second direction. That is, the tube does not protrude toward a portion near the second direction side from the cluster block. As a result, the cooling medium path which can be easily widened since the terminal-side lead wires are not densely disposed can be inhibited from being closed by the tube, and coil cooling efficiency can thus be enhanced.

In the stator unit according to a third aspect, in addition to the effect exhibited by the stator unit according to the first aspect, the following effect is exhibited. The bobbin includes an outer circumferential wall portion and an inner circumferential wall portion which protrude toward an opposite side to the stator core side with respect to the coil. The outer circumferential wall portion is disposed along an outer side of the coil in the radial direction in the bobbin, and the inner circumferential wall portion is disposed along an inner side of the coil in the radial direction in the bobbin. The plurality of terminal-side lead wires, the plurality of neutral-point-side lead wires, and the tube are fixed by winding a thread on either one of the outer circumferential wall portion and the inner circumferential wall portion. Thus, on the opposite side to the side on which the tube and the like are fixed, i.e., on the other of the outer circumferential wall portion side and the inner circumferential wall portion side, the cooling medium path is made unlikely to be closed by the terminal-side lead wires, the neutral-point-side lead wires, and the tube. That is, the cooling medium path can be easily widened at the other of the outer circumferential wall portion side and the inner circumferential wall portion side, and coil cooling efficiency can be enhanced.

In the stator unit according to a fourth aspect, in addition to the effect exhibited by the stator unit according to the third aspect, the following effect is exhibited. In the circumferential direction of the bobbin, a direction in which an end of the tube faces is a second direction. The plurality of neutral-point-side lead wires extend from the coils, respectively, in the second direction and gradually merge. An end side portion of the tube and the cluster block overlap the coil with which one of the neutral-point-side lead wires merely overlaps as viewed in the axial direction. A space for disposing an object other than the neutral-point-side lead wire can be widened in a space portion between the bottom surface of the cluster block and the coil at such a portion with which one wire merely overlaps as compared with other portions. Thus, enlargement of the space portion for disposing the tube in the space can be minimized, so that the stator unit can be made small.

In the stator unit according to a fifth aspect, in addition to the effect exhibited by the stator unit according to the first aspect, the following effect is exhibited. The cluster block includes a bottom plate having the bottom surface, a first through hole penetrating through the bottom plate in the axial direction, and a wall portion having a regulation surface facing toward the first through hole, the wall portion extending toward the stator core from the bottom surface. By inserting, in the first through hole, a protrusion protruding from the axial end surface of the bobbin, movement of the cluster block relative to the bobbin in directions other than the axial direction is basically regulated. Furthermore, in a state where a contact surface is brought into contact with the regulation surface, a projection projecting from the end of the protrusion in the same direction as the direction in which the regulation surface faces opposes a part of the bottom plate around the first through hole in the axial direction. Therefore, the projection is caught by the bottom plate, and movement of the cluster block relative to the bobbin in the axial direction is also regulated. Even if the bottom plate is attempted to be relatively moved in the projecting direction of the projection in order to release the opposing, the relative movement is regulated by contact between the contact surface of the bobbin and the regulation surface of the wall portion, and releasing of the opposing can be inhibited. As a result, the cluster block can be made unlikely to be detached from the bobbin.

Meanwhile, when the cluster block is mounted to the bobbin, the projection and the protrusion are firstly inserted into the first through hole in a state where the bottom plate is inclined such that the wall portion side of the bottom plate is away from the bobbin. Thereafter, the wall portion side of the bottom plate is inclined by using the first through hole as a pivot, and the regulation surface is caused to oppose the contact surface while the bottom surface of the bottom plate is brought into contact with the axial end surface of the bobbin, and thus, the cluster block can be easily mounted. As a result, the cluster block can be easily mounted to the bobbin, and simultaneously, detachment of the cluster block can be made difficult after the cluster block has been mounted. Furthermore, since the cluster block is thus unlikely to be detached, the cluster block can be inhibited from floating from the bobbin due to, for example, an elastic reaction force of the tube disposed between the bottom surface of the cluster block and the coil.

Therefore, the size of the stator unit in the axial direction can be inhibited from being increased due to the floating.

An electric motor according to a sixth aspect, an air-conditioning apparatus according to a seventh aspect, a refrigerator according to an eighth aspect, and an on-vehicle apparatus according to a ninth aspect each include the stator unit according to any one of the first to the fifth aspects, and each have the effect exhibited by the stator unit.

### BRIEF DESCRIPTION OF THE DRAWINGS

FIG. 1A is a block diagram schematically illustrating a vehicle to which an electric motor according to a first embodiment is mounted.

FIG. 1B is a cross-sectional view schematically illustrating an electric compressor.

FIG. 2 is a half sectional view of a stator unit at a line II-II in FIG. 1B.

FIG. 3 is a top view of the stator unit for schematically illustrating terminal-side lead wires.

FIG. 4 is a top view of the stator unit for schematically illustrating neutral-point-side lead wires.

FIG. 5A is a cross-sectional view of a tube and the neutral-point-side lead wires at a line Va-Va in FIG. 4.

FIG. 5B is a side view of the tube and the neutral-point-side lead wires as viewed in an arrow Vb direction in FIG. 5A.

FIG. 6A is a top view of the stator unit for schematically illustrating a thread for fixing the terminal-side lead wires and the neutral-point-side lead wires.

FIG. 6B is a cross-sectional view of the stator unit at a line VIb-VIb in FIG. 6A.

FIG. 7A is a cross-sectional view of the stator unit at a line VIIa-VIIa in FIG. 2.

FIG. 7B is a cross-sectional view of the stator unit at a line VIIb-VIIb in FIG. 2.

FIG. 8A is a top view of a stator unit having a cluster block according to a second embodiment.

FIG. 8B is a perspective view of the cluster block.

FIG. 9A is a block diagram schematically illustrating an air-conditioning apparatus having the electric motor mounted thereto.

FIG. 9B is a block diagram schematically illustrating a refrigerator having the electric motor mounted thereto.

### DESCRIPTION OF THE PREFERRED EMBODIMENTS

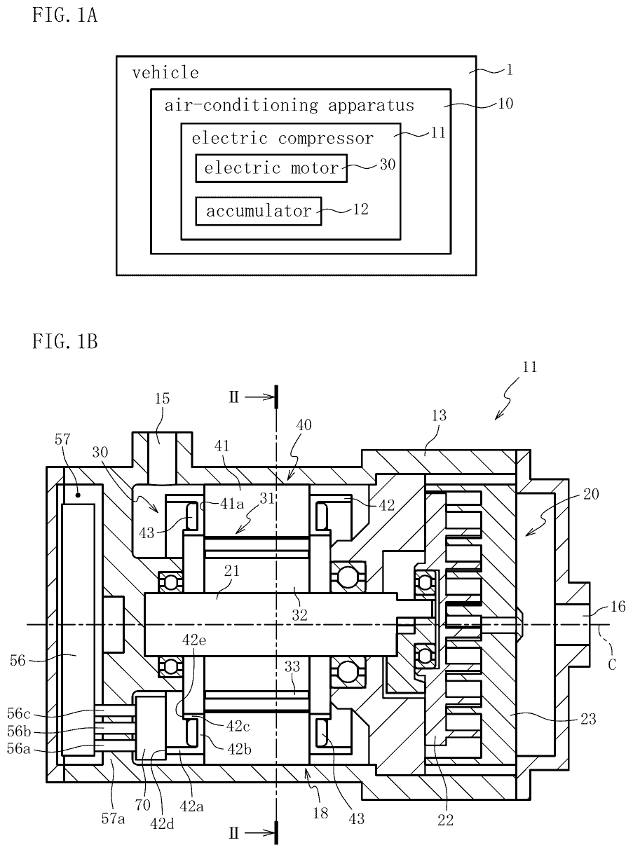

Preferred embodiments will be described below with reference to the accompanying drawings. FIG. 1A is a block diagram schematically illustrating a vehicle 1 having an air-conditioning apparatus 10 to which an electric compressor 11 including an electric motor 30 according to a first embodiment is mounted. FIG. 1B is a cross-sectional view schematically illustrating the electric compressor 11. In FIG. 1B, hatching of some (rotor 31, stator 40, and the like) of parts of the electric compressor 11 is omitted for simplifying the drawing.

As shown in FIG. 1A and FIG. 1B, the air-conditioning apparatus 10 (on-vehicle apparatus) of the vehicle 1 is an apparatus for sending cool air generated by the electric compressor 11 to an inner space of the vehicle 1. The electric compressor 11 mainly includes a compressing portion 20, the electric motor 30, and an accumulator 12. The compressing portion 20 and the electric motor 30 are disposed in a sealed container 13. In the sealed container 13, a suction tube 15 and a discharge tube 16 that connect between the outside and the inside of the sealed container 13 are disposed.

The accumulator 12 is for separating lubricating oil and a cooling medium (for example, cooling gas) as a fluid from each other. The cooling medium separated by the accumulator 12 is returned through the suction tube 15 to the compressing portion 20. The lubricating oil separated by the accumulator 12 is returned into a lubricating oil reservoir in the sealed container 13. The air-conditioning apparatus 10 may include a receiver for storing compressed cooling medium in addition to the accumulator 12 or instead of the accumulator 12.

The compressing portion 20 includes a rotation shaft 21, an orbiting scroll 22 driven by the electric motor 30 through the rotation shaft 21, and a fixed scroll 23 fixed to the sealed container 13. The rotation shaft 21 is a rod-like member that rotates around an axis C that is the axis of the rotation shaft 21. The compressing portion 20 rotates the orbiting scroll 22 around the axis C to turn the orbiting scroll 22, and compresses the cooling medium suctioned through the suction tube 15 between a spiral wrap disposed in the orbiting scroll 22, and a spiral wrap disposed in the fixed scroll 23 so as to mate with the spiral wrap disposed in the orbiting scroll 22. Hereinafter, the axial direction of the axis C is referred to as “axis C direction”, the direction orthogonal to the axis C is referred to as “radial direction”, and the direction around the axis C is referred to as “circumferential direction”.

The cooling medium compressed by the compressing portion 20 is discharged through the discharge tube 16. The electric compressor 11 of the present embodiment discharges a medium in which the cooling medium and a lubricating oil are mixed through the discharge tube 16. The compressing portion 20 is not limited to the above-described scroll-type one, and may be, for example, a reciprocating-type, a rotary-type, or a screw-type one.

The electric motor 30 is a three-phase AC motor. The electric motor 30 includes a cylindrical stator 40 fixed to the sealed container 13, a cylindrical rotor 31 disposed on the inner circumferential side of the stator 40, and a cluster block 70 formed as a box-like member. The rotor 31 surrounds the axis C, and the stator 40 surrounds the rotor 31. A stator unit 18 is formed by the stator 40 and the cluster block 70.

The rotor 31 includes a cylindrical rotor core 32 formed by stacking a plurality of thin sheet-like electromagnetic steel sheets in the axis C direction, and a plurality of permanent magnets 33 embedded in the rotor core 32. The rotation shaft 21 is inserted in the inner circumferential side of the rotor core 32, and the rotation shaft 21 is fixed to the rotor core 32 by press-fitting, shrink fitting, or the like. The plurality of permanent magnets 33 are disposed rotationally symmetrically around the axis C. The permanent magnets 33 may be embedded so as to be exposed at the outer circumferential surface of the rotor core 32, or embedded so as not to be exposed.

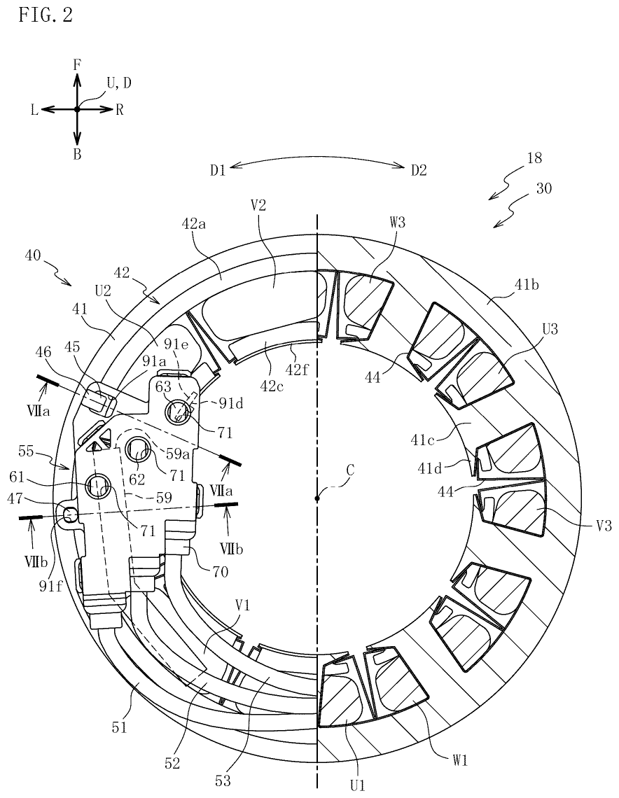

FIG. 2 is a half sectional view of the stator unit 18 at a line II-II in FIG. 1B. Specifically, in FIG. 2, the right half portion is a cross-sectional view of the stator unit 18, and the left half portion is a top view thereof.

As shown in FIG. 1B and FIG. 2, the stator 40 of the stator unit 18 mainly includes a cylindrical stator core 41 fixed to the inner circumferential surface of the sealed container 13, a cylindrical bobbin 42 disposed at each of axial end surfaces 41a on both sides of the stator core 41, and a coil 43 wound around the bobbin 42 and the stator core 41.

The stator core 41 is formed by stacking a plurality of thin sheet-like electromagnetic steel sheets in the axis C direction. The stator core 41 may be formed of an annular electromagnetic steel sheet continuous in the circumferential direction into a cylindrical shape, or formed into a cylindrical shape by connecting a plurality of electromagnetic steel sheets divided in the circumferential direction or the radial direction. The stator core 41 includes a cylindrical yoke portion 41b forming an outer circumferential portion of the stator core 41, and a plurality of tooth portions 41c protruding from the inner circumferential surface of the yoke portion 41b toward the axis C. Inner circumferential end portions 41d on the rotor 31 side in the tooth portion 41c protrude on both sides in the circumferential direction.

The plurality of tooth portions 41c have the same shape, and are aligned at regular intervals in the circumferential direction. A plurality of slots are formed between the tooth portions 41c adjacent in the circumferential direction. In the present embodiment, the number of the tooth portions 41c and the number of the slots are each nine, but may be changed to another multiple of 3 (which needs to be 6 or more) as appropriate.

The concentrated-winding-type coil 43 is inserted in the slot. In order to prevent the coil 43 from being in direct contact with the inner circumferential surface of the yoke portion 41b, both surfaces of the tooth portion 41c in the circumferential direction, and the outer circumferential surface of the inner circumferential end portion 41d, and to prevent the coils 43 wound around the tooth portions 41c, respectively, adjacent to each other from being in contact with each other, a plurality of insulating buffer sheets 44 are disposed therebetween.

The bobbin 42 is an insulating member for preventing the coil 43 from coming into direct contact with the axial end surface 41a of the stator core 41. The bobbin 42 may be integrally formed in the circumferential direction or may be formed by connecting a plurality of members divided in the circumferential direction or the radial direction, similarly to the stator core 41. The bobbin 42 includes an outer circumferential wall portion 42a that has a cylindrical shape and protrudes from the axial end surface 41a in the yoke portion 41b in the axis C direction, a plurality of wall connection portions 42b extending inward in the radial direction from the lower portion of the outer circumferential wall portion 42a along the tooth portions 41c, and a plurality of inner circumferential wall portions 42c each protruding in the axis C direction from the end portion of the wall connection portion 42b on the inner side in the radial direction.

The plurality of wall connection portions 42b have the same shape, and are aligned at regular intervals in the circumferential direction. The plurality of inner circumferential wall portions 42c also have the same shape, and are aligned at regular intervals in the circumferential direction. The number of the wall connection portions 42b and the number of the inner circumferential wall portions 42c are each equal to the number of the tooth portions 41c. The wall connection portion 42b is disposed at the axial end surface 41a in the tooth portion 41c and the inner circumferential end portion 41d, and has almost the same width as the width of the tooth portion 41c excluding the inner circumferential end portion 41d in the circumferential direction. The inner circumferential wall portion 42c is disposed above the inner circumferential end portion 41d, and the width of the inner circumferential wall portion 42c in the circumferential direction is almost the same as the width of the inner circumferential end portion 41d in the circumferential direction.

An axial end surface 42e of the inner circumferential wall portion 42c on the opposite side to the stator core 41 side is disposed on the stator core 41 side at a lower position than an axial end surface 42d of the outer circumferential wall portion 42a on the opposite side to the stator core 41 side.

The cluster block 70 is disposed so as to come into contact with the axial end surface 42d at one of the bobbins 42 on both sides in the axis C direction. Hereinafter, a side in the axis C direction on which the cluster block 70 is disposed is referred to as upper side of the electric motor 30 (stator unit 18), and a side on which the cluster block 70 is not disposed is referred to as lower side of the electric motor 30 (stator unit 18).

A partition wall portion 57a for partitioning the sealed container 13 in the axis C direction is disposed above the cluster block 70. The electric motor 30 is disposed in a space below the partition wall portion 57a. A control circuit 56 for performing drive control of the electric motor 30 is disposed in a space 57 above the partition wall portion 57a. The space 57 may be disposed outside the sealed container 13, and a part of an outer wall of the sealed container 13 may serve as the partition wall portion 57a.

Three mating terminals 56a, 56b, 56c corresponding to a U phase, a V phase, and a W phase, respectively, protrude downward from the control circuit 56. The mating terminals 56a to 56c are columnar metal terminals that are electrically connected to the control circuit 56. The mating terminals 56a to 56c penetrate through the partition wall portion 57a, and protrude into a space in which the electric motor 30 is disposed.

The coil 43 is formed by a conductor wound around each of the nine (multiple of 3) tooth portions 41c and the bobbin 42 in a concentrated winding manner, and nine (multiple of 3) coils 43 are aligned in the circumferential direction. The nine coils 43 are each stored in a portion surrounded by the outer circumferential wall portion 42a, the wall connection portion 42b, and the inner circumferential wall portion 42c of the bobbin 42. That is, the outer circumferential wall portion 42a is disposed along the outer side of the coil 43 in the radial direction and protrudes upward with respect to the coil 43 (toward the opposite side to the stator core 41 side). The inner circumferential wall portion 42c is disposed along the inner side of the coil 43 in the radial direction and protrudes upward with respect to the coil 43.

Nine (multiple of 3) cooling medium paths connecting to both sides of the stator 40 in the axis C direction are each formed between the coils 43 in the circumferential direction. A cooling medium passes through the plurality of cooling medium paths and thus cools the coil 43.

The nine coils 43 are implemented by a three-phase coil having a U phase, a V phase, and a W phase. The nine coils 43 are formed of U-phase coils U1, U2, U3, V-phase coils V1, V2, V3, and W-phase coils W1, W2, W3. The coils are aligned clockwise as shown in FIG. 2 in the order of the U phase, the V phase, and the W phase. Specifically, the coils are aligned clockwise as shown in FIG. 2 in the order of U1, V1, W2, U2, V2, W3, U3, V3, W1. In FIG. 2, the coil W2 is hidden below the cluster block 70 (depth side in the drawing sheet surface). The clockwise direction in FIG. 2 is defined as second direction D2, and the counterclockwise direction opposite to the second direction D2 is defined as first direction D1.

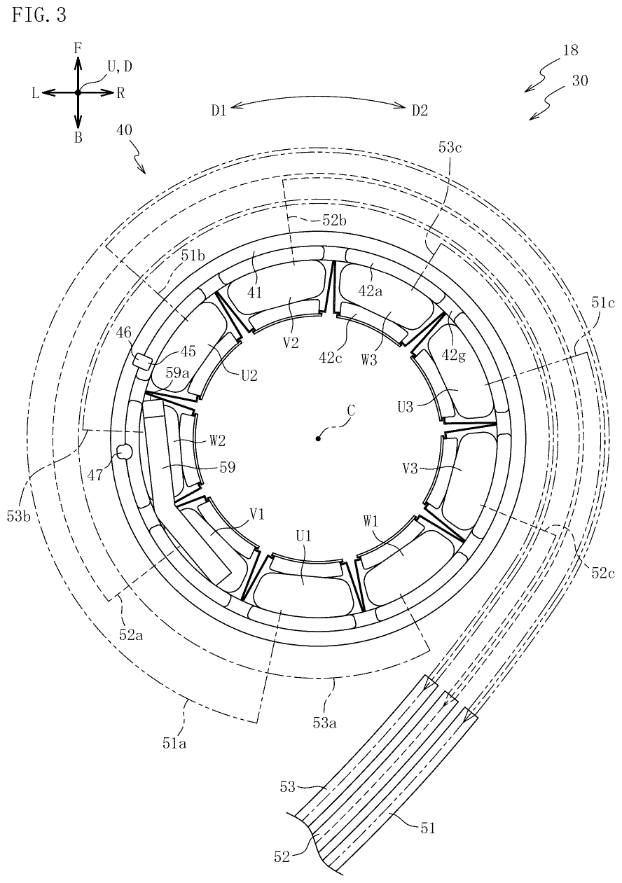

FIG. 3 is a top view of the stator unit 18 and schematically illustrates terminal-side lead wires 51a to 53c. In FIG. 3, the cluster block 70 is not shown. In FIG. 3, the terminal-side lead wires 51a to 51c are indicated by alternate long and two short dashed lines, the terminal-side lead wires 52a to 52c are indicated by dashed lines, and the terminal-side lead wires 53a to 53c are indicated by alternate long and short dash lines.

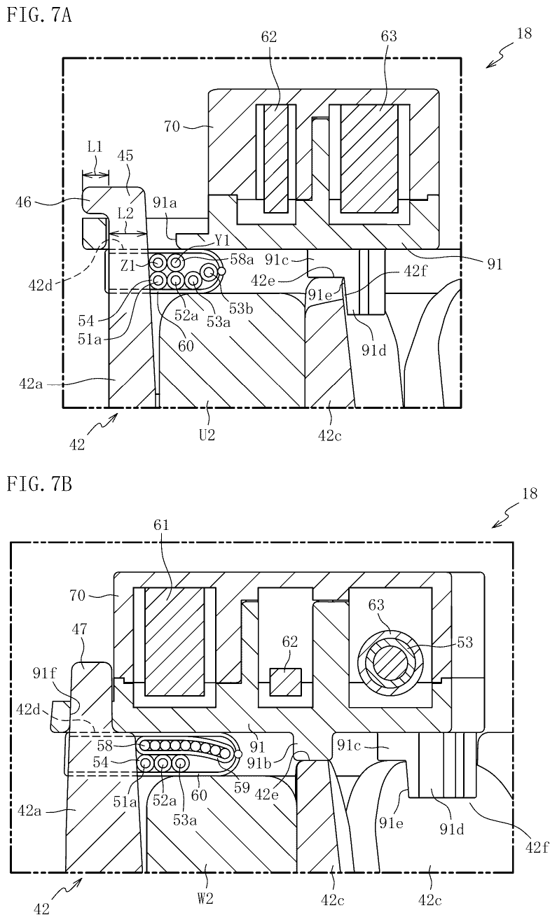

The terminal-side lead wires 51a to 53c are wires that are each connected to one end of a corresponding one of conductors forming the respective coils U1 to W3 and are extracted from the respective coils U1 to W3. Each of the terminal-side lead wires 51a to 53c is basically formed by covering a conductor with an individual covering material 54 (see FIG. 7A) formed of an insulating elastic material. The terminal-side lead wires 51a to 53c are disposed on the coils U1 to W3 between the outer circumferential wall portion 42a and the inner circumferential wall portion 42c (see FIG. 7A).

The terminal-side lead wire 51a is extracted from the coil U1, the terminal-side lead wire 51b is extracted from the coil U2, and the terminal-side lead wire 51c is extracted from the coil U3. The terminal-side lead wires 51a to 51c extend from the coils U1 to U3, respectively, in the second direction D2, and gradually merge in the order of the terminal-side lead wires 51a, 51b, 51c. The merged terminal-side lead wires 51a to 51c are collectively inserted in a tubular covering material formed of an insulating elastic material near the coil W1 (on the coil W1), and the conductors exposed from the individual covering materials 54 inside the covering material are electrically connected. The portion in which the three conductors are electrically connected is a terminal-side lead wire 51.

The terminal-side lead wire 52a is extracted from the coil V1, the terminal-side lead wire 52b is extracted from the coil V2, and the terminal-side lead wire 52c is extracted from the coil V3. The terminal-side lead wires 52a to 52c extend from the coils V1 to V3, respectively, in the second direction D2, and gradually merge in the order of the terminal-side lead wires 52a, 52b, 52c. The merged terminal-side lead wires 52a to 52c are collectively inserted in a tubular covering material formed of an insulating elastic material near the coil W1, and the conductors exposed from the individual covering materials 54 inside the covering material are electrically connected. The portion in which the three conductors are electrically connected is a terminal-side lead wire 52.

The terminal-side lead wire 53a is extracted from the coil W1, the terminal-side lead wire 53b is extracted from the coil W2, and the terminal-side lead wire 53c is extracted from the coil W3. The terminal-side lead wires 53a to 53c extend from the coils W1 to W3, respectively, in the second direction D2, and gradually merge in the order of the terminal-side lead wires 53a, 53b, 53c. The merged terminal-side lead wires 53a to 53c are collectively inserted in a tubular covering material formed of an insulating elastic material near the coil W1, and the conductors exposed from the individual covering materials 54 inside the covering material are electrically connected. The portion in which the three conductors are electrically connected is a terminal-side lead wire 53.

As shown in FIG. 2, the end sides (on sides apart from the coils U1 to W3) of the terminal-side lead wires 51 to 53 are inserted into the cluster block 70 formed as an insulating box-like member. In the cluster block 70, a U-phase connection terminal 61 to which the terminal-side lead wire 51 is electrically connected, a V-phase connection terminal 62 to which the terminal-side lead wire 52 is electrically connected, and a W-phase connection terminal 63 to which the terminal-side lead wire 53 is electrically connected, are stored.

These three-phase connection terminals 61, 62, 63 are aligned in the cluster block 70 in this order from the outer side toward the inner side in the radial direction.

The terminal-side lead wires 51, 52, 53 extending from the cluster block 70 in the first direction D1 are also aligned in this order from the outer side toward the inner side in the radial direction.

Insertion holes 71 are formed in a top plate forming the upper surface of the cluster block 70 at such positions that the upper sides of the respective connection terminals 61 to 63 are covered, and penetrate through the top plate. The mating terminals 56a, 56b, 56c (see FIG. 1B) that are columnar metal terminals are inserted in the insertion holes 71. Thus, the U-phase mating terminal 56a is electrically connected to the connection terminal 61, the V-phase mating terminal 56b is electrically connected to the connection terminal 62, and the W-phase mating terminal 56c is electrically connected to the connection terminal 63.

The control circuit 56 (see FIG. 1B) serves as an inverter for controlling an electric current flowing in the coils U1 to W3 through the mating terminals 56a to 56c, the connection terminals 61 to 63, and the terminal-side lead wires 51 to 53 and 51a to 53c. The control circuit 56 operates to generate a magnetic field for rotating the rotor 31 by the electric current, and performs drive control of the electric motor 30.

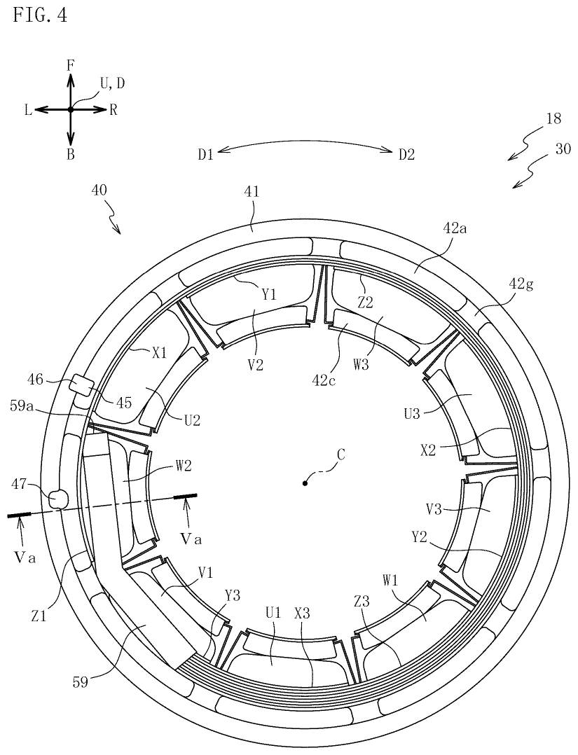

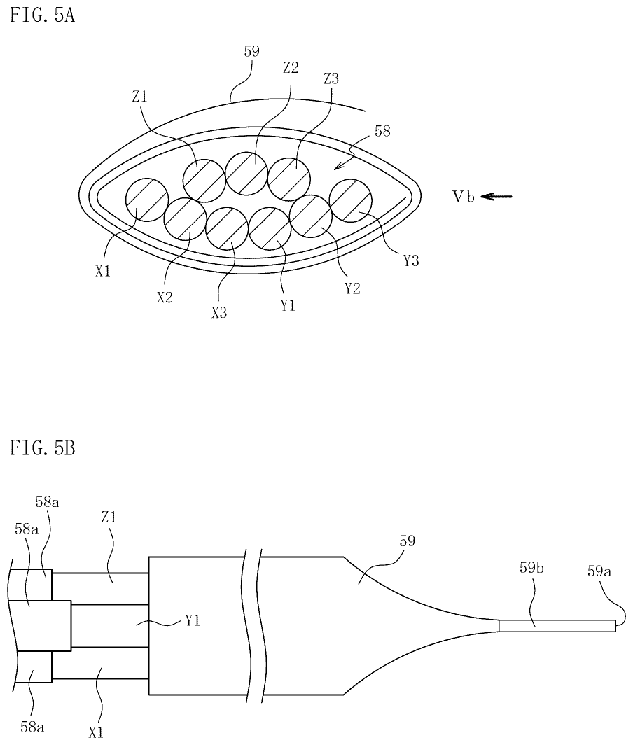

FIG. 4 is a top view of the stator unit 18 and schematically illustrates neutral-point-side lead wires X1 to Z3. In FIG. 4, the cluster block 70 is not shown. The neutral-point-side lead wires X1 to Z3 are wires that are each connected to the other end (ends on the opposite sides to the terminal-side lead wire 51a to 53c sides) of a corresponding one of the conductors forming the respective coils U1 to W3 and are extracted from the respective coils U1 to W3. Each of the neutral-point-side lead wires X1 to Z3 is basically formed by covering a conductor with a covering material 58a (see FIG. 5B) formed of an insulating elastic material. The neutral-point-side lead wires X1 to Z3 are disposed on the coils U1 to W3 between the outer circumferential wall portion 42a and the inner circumferential wall portion 42c.

The neutral-point-side lead wire X1 is extracted from the coil U2, the neutral-point-side lead wire X2 is extracted from the coil U3, and the neutral-point-side lead wire X3 is extracted from the coil U1. The neutral-point-side lead wire Y1 is extracted from the coil V2, the neutral-point-side lead wire Y2 is extracted from the coil V3, and the neutral-point-side lead wire Y3 is extracted from the coil V1. The neutral-point-side lead wire Z1 is extracted from the coil W2, the neutral-point-side lead wire Z2 is extracted from the coil W3, and the neutral-point-side lead wire Z3 is extracted from the coil W1.

The neutral-point-side lead wires X1 to Z3 extend from the coils U1 to W3, respectively, in the second direction D2, and gradually merge in the order of the neutral-point-side lead wires Z1, X1, Y1, Z2, X2, Y2, Z3, X3, Y3. The merged neutral-point-side lead wires X1 to Z3 are collectively inserted in a tubular bag-like tube 59 formed of an insulating elastic material on the coil V1. The tube 59 is disposed on the coils V1, W2 between the outer circumferential wall portion 42a and the inner circumferential wall portion 42c.

FIG. 5A is a cross-sectional view of the tube 59 and the neutral-point-side lead wires X1 to Z3 at a line Va-Va in FIG. 4. FIG. 5B is a side view of the tube 59 and the neutral-point-side lead wires X1 to Z3 as viewed in an arrow Vb direction in FIG. 5A. In FIG. 5B, a part of the neutral-point-side lead wires X1 to Z3 overlapping in the direction perpendicular to the drawing sheet surface is not shown.

Before each of the neutral-point-side lead wires X1 to Z3 is inserted in the tube 59, the conductor is exposed from the covering material 58a. A neutral point 58 is formed by electrically connecting the exposed conductors to each other to connect the neutral-point-side lead wires X1 to Z3 to each other. Thus, Y connection between the three-phase coils U1 to W3 is made.

The tube 59 covers the neutral point 58 to insulate the neutral point 58 from the coils U1 to W3 and the like. An insulating film is rolled and a plurality of layers overlap each other, and a part of an end 59a side portion is thereafter subjected to thermocompression bonding in the up-down direction to form a compression-bonded portion 59b, and thus, the tube 59 is formed into a tubular bag-like shape in which the end 59a is closed.

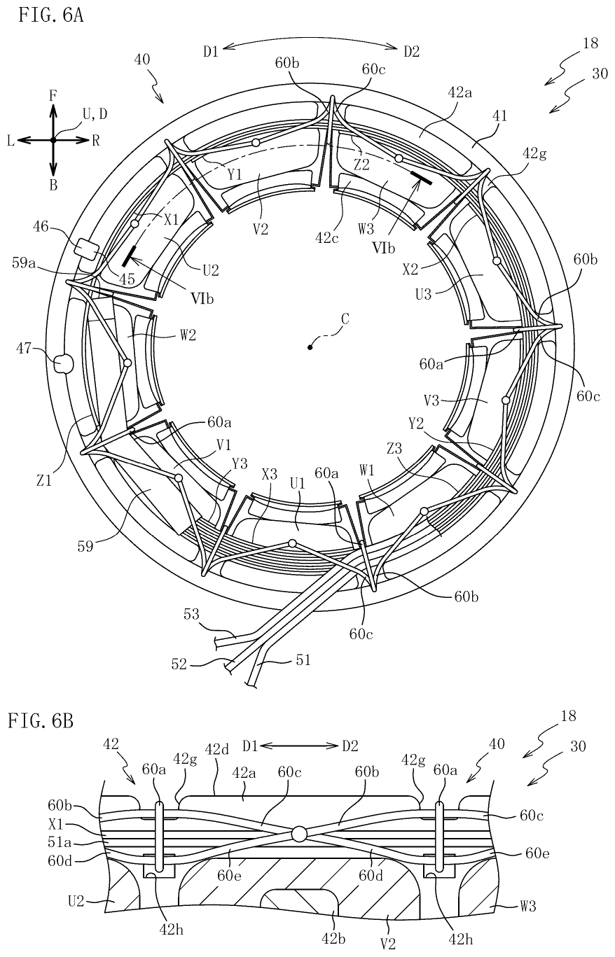

FIG. 6A and FIG. 6B schematically illustrate threads 60a to 60e for fixing the plurality of terminal-side lead wires 51 to 53 and 51a to 53c, the plurality of neutral-point-side lead wires X1 to Z3, and the tube 59 (hereinafter, referred to as “tube 59 and the like”) to the bobbin 42. FIG. 6A is a top view of the stator unit 18. FIG. 6B is a cross-sectional view of the stator unit 18 at a line VIb-VIb in FIG. 6A. In FIG. 6A and FIG. 6B, a part of the terminal-side lead wires 51a to 53c and the neutral-point-side lead wires X1 to Z3 overlapping in the direction perpendicular to the drawing sheet surface are not shown.

A recess 42g which is recessed downward from the axial end surface 42d is formed at the outer circumferential wall portion 42a of the bobbin 42 at each of portions between the nine coils U1 to W3. Furthermore, a through hole 42h penetrating through the outer circumferential wall portion 42a in the radial direction is formed below each of the nine recesses 42g at each of the portions between the nine coils U1 to W3.

The tube 59 and the like are fixed to the outer circumferential wall portion 42a by the threads 60a to 60e which are wound on the outer circumferential wall portion 42a so as to pass through the recess 42g and the through hole 42h. The thread 60a connects between the recess 42g and the through hole 42h in the up-down direction, and thus presses the tube 59 and the like against the inner circumferential surface of the outer circumferential wall portion 42a.

The threads 60b to 60e are entangled with the thread 60a at the outer circumferential surface side of the outer circumferential wall portion 42a, and extend from the recess 42g or the through hole 42h onto the inner circumferential surface side of the outer circumferential wall portion 42a. On the inner circumferential surface side of the outer circumferential wall portion 42a, the thread 60b extends downward in the first direction D1 from the recess 42g and the thread 60c extends downward in the second direction D2 from the recess 42g, and similarly, the thread 60d extends upward in the first direction D1 from the through hole 42h and the thread 60e extends upward in the second direction D2 from the through hole 42h. The threads 60b to 60e are entangled with each other above the coils U1 to W3 at the center in the circumferential direction. Thus, the tube 59 and the like are pressed against the inner circumferential surface of the outer circumferential wall portion 42a by the threads 60b to 60e also at the centers of the respective coils U1 to W3 in the circumferential direction.

The tube 59 and the like are fixed so as to be pressed against the outer circumferential wall portion 42a over the entire circumference, by such threads 60a to 60e. The terminal-side lead wires 51 to 53 are not fixed to the outer circumferential wall portion 42a by the threads 60a to 60e on the coil U1, and extend toward the cluster block 70.

Next, with reference to FIG. 2, FIG. 7A, and FIG. 7B, a structure for mounting the cluster block 70 to the bobbin 42 will be described. FIG. 7A is a cross-sectional view of the stator unit 18 at a line VIIa-VIIa in FIG. 2. FIG. 7B is a cross-sectional view of the stator unit 18 at a line VIIb-VIIb in FIG. 2. In FIG. 7A and FIG. 7B, the threads 60a to 60e are schematically illustrated as a thread 60.

In the following description for the cluster block 70, unless otherwise specified, the inner side (right side on the drawing sheet surface in FIG. 2) in the radial direction of the axis C is defined as the right side of the cluster block 70, and the outer side (left side on the drawing sheet surface in FIG. 2) in the radial direction of the axis C is defined as the left side of the cluster block 70. In the cluster block 70, the direction in which the end portion in the second direction D2 faces is defined as the front direction, and the direction opposite to the front direction is defined as the rear direction. In each of the drawings, an arrow U direction, an arrow D direction, an arrow F direction, an arrow B direction, an arrow L direction, and an arrow R direction represent the upper direction, the lower direction, the front direction, the rear direction, the left direction, and the right direction, respectively, of the cluster block 70.

The cluster block 70 is a box-like member divided in two portions in the upper-lower direction, and holds and stores the connection terminals 61 to 63 between the two upper and lower members. The cluster block 70 is not limited to the structure formed of the two upper and lower members and may be formed of one member or formed of three or more members.

The cluster block 70 is disposed mainly on the coils W2, U2, and the rear end portion protrudes on the coil V1. That is, the cluster block 70 is disposed so as to extend between the coils W2 and U2 and between the coils V1 and W2.

The cluster block 70 includes a bottom plate 91 forming a bottom surface (lower surface) of the cluster block 70. The terminal-side lead wires 51a, 52a, 53a, 53b, the neutral-point-side lead wires Y1, Z1, and the tube 59 containing the neutral point 58 are disposed between the bottom surface of the bottom plate 91 and the coils W2, U2.

The bottom surface of the bottom plate 91 comes into contact with the axial end surfaces 42d, 42e of the bobbin 42. The axial end surface 42e is positioned at a lower position in the lower direction than the axial end surface 42d, and the bottom surface of the bottom plate 91 is structured so as to absorb the difference in the height. Specifically, the bottom surface of the bottom plate 91 has adjusting protrusions 91b, 91c protruding downward, at a position corresponding to the axial end surface 42e, and the lower ends of the adjusting protrusions 91b, 91c come into contact with the axial end surface 42e.

As shown in FIG. 2 and FIG. 7A, a first through hole 91a penetrating through the bottom plate 91 in the up-down direction is formed at a portion of the bottom plate 91 which protrudes forward from the front wall of the cluster block 70. A protrusion 45 to be inserted into the first through hole 91a protrudes from the axial end surface 42d of the bobbin 42. Thus, movement of the cluster block 70 relative to the bobbin 42 in directions other than the upper direction is basically regulated.

Furthermore, the end of the protrusion 45 inserted in the first through hole 91a is positioned upward of the bottom plate 91, and a projection 46 projects outward from the end in the radial direction of the axis C. Thus, a part of the bottom plate 91 around the first through hole 91a and the projection 46 oppose each other in the up-down direction. As a result, when the cluster block 70 is moved upward relative to the bobbin 42, the bottom plate 91 is caught by the projection 46, and thus, the upward movement of the cluster block 70 can also be regulated.

A wall portion 91d having a regulation surface 91e which faces toward the first through hole 91a in the protruding direction of the protrusion 45 protrudes so as to extend downward from the bottom surface of the bottom plate 91. In the present embodiment, the first through hole 91a is displaced rearward in the circumferential direction from the front surface position of the regulation surface 91e as viewed in the up-down direction. The wall portion 91d is connected to the adjusting protrusion 91c such that the regulation surface 91e protrudes from the adjusting protrusion 91c. The regulation surface 91e comes into contact with a contact surface 42f that is an inner circumferential wall surface of the inner circumferential wall portion 42c in a state where the protrusion 45 is inserted in the first through hole 91a, and a part of the bottom plate 91 around the first through hole 91a and the projection 46 oppose each other in the up-down direction.

Thus, even if the bottom plate 91 is attempted to be relatively moved in the projecting direction of the projection 46 so as to release opposing of the bottom plate 91 and the projection 46, the relative movement is regulated by the contact between the regulation surface 91e and the contact surface 42f, and releasing of the opposing can be inhibited. As a result, the cluster block 70 can be made unlikely to be detached from the bobbin 42.

Meanwhile, when the cluster block 70 is mounted to the bobbin 42, the projection 46 and the protrusion 45 are firstly inserted into the first through hole 91a in a state where the bottom plate 91 is inclined such that the wall portion 91d side portion of the bottom plate 91 is away from the inner circumferential wall portion 42c of the bobbin 42. The length of the first through hole 91a in the projecting direction of the projection 46 is larger than the total of the projection length L1 of the projection 46 from the protrusion 45 to the end of the projection 46, and the thickness L2 in the dimensions of the protrusion 45 in the projecting direction of the projection 46. Thus, the protrusion 45 and the projection 46 can be easily inserted into the first through hole 91a.

After the insertion into the first through hole 91a, the wall portion 91d side portion of the bottom plate 91 is inclined by using the first through hole 91a as a pivot, and the regulation surface 91e is caused to oppose the contact surface 42f while the bottom plate 91 is brought into contact with the axial end surfaces 42d, 42e of the bobbin 42. Thus, the cluster block 70 can be easily mounted to the bobbin 42. As a result, the cluster block 70 can be easily mounted to the bobbin 42, and simultaneously, detachment of the cluster block 70 from the bobbin 42 after the mounting of the cluster block 70 can be made difficult.

The projection length L1 of the projection 46 is half or more the thickness L2 of the protrusion 45 in the first through hole 91a. Thus, since the projection length L1 is ensured to some degree, opposing of the bottom plate 91 and the projection 46 can be inhibited from being released due to the projection 46 being disengaged from the first through hole 91a by, for example, deformation of the protrusion 45 and the projection 46. Therefore, the cluster block 70 can be made more unlikely to be detached from the bobbin 42.

The bottom plate 91 is continuous around the entire periphery of the first through hole 91a, and the first through hole 91a is not opened over the entire periphery. Therefore, the bottom plate 91 around the first through hole 91a can be made unlikely to be deformed, and opposing of the bottom plate 91 and the projection 46 can be inhibited from being released due to the projection 46 being disengaged from the first through hole 91a according to the deformation. Therefore, the cluster block 70 can be made more unlikely to be detached from the bobbin 42.

Since the terminal-side lead wires 51 to 53 extending from the cluster block 70 are curved along the circumferential direction around the axis C, a force is applied to the cluster block 70 toward the outer side in the radial direction relative to the bobbin 42 of the electric motor 30 due to an elastic reaction force of the terminal-side lead wires 51 to 53. The contact surface 42f is an inner circumferential wall surface facing inward in the radial direction in the bobbin 42. Therefore, the regulation surface 91e of the cluster block 70 is pressed against the contact surface 42f due to the elastic reaction force. Thus, contact between the contact surface 42f and the regulation surface 91e can be easily maintained due to the elastic reaction force of the terminal-side lead wires 51 to 53, and accuracy for positioning the cluster block 70 relative to the bobbin 42 in the radial direction can be enhanced.

As shown in FIG. 2 and FIG. 7B, a portion protruding leftward from the left wall of the cluster block 70 in the bottom plate 91 has a second through hole 91f penetrating through the bottom plate 91 in the up-down direction. The second through hole 91f is disposed so as to be distant from the first through hole 91a in the direction (the front-rear direction of the cluster block 70) perpendicular to the projecting direction of the projection 46.

An insertion portion 47 that can be inserted into the second through hole 91f protrudes from the axial end surface 42d of the bobbin 42. The insertion portion 47 is implemented as a pin in which the entire periphery of the outer peripheral surface is exposed, and does not have a portion projecting in the radial direction, such as the projection 46. The size of the insertion portion 47 is set such that the insertion portion 47 fits into the second through hole 91f through a slight gap.

After the insertion portion 47 is thus inserted into the second through hole 91f, and the cluster block 70 is mounted to the bobbin 42, even if the cluster block 70 is attempted to be inclined merely in the projecting direction of the projection 46 by using the first through hole 91a as a pivot, the bottom plate 91 around the second through hole 91f and the insertion portion 47 interfere with each other, and the inclination is difficult. Meanwhile, in a case where the cluster block 70 is inclined so as to lift the linear line portion connecting the wall portion 91d and the second through hole 91f to each other by using the first through hole 91a as a pivot, the bottom plate 91 and the insertion portion 47 are unlikely to interfere with each other, and the contact surface 42f and the regulation surface 91e are unlikely to interfere with each other, so that the inclination can be facilitated. By such inclination, the cluster block 70 can be easily detached from the bobbin 42 and the cluster block 70 can be easily mounted to the bobbin 42. Therefore, in a case where an operator knows the method for mounting the cluster block 70, reduction of the mountability can be inhibited, and furthermore, the cluster block 70 can be inhibited from being unintentionally detached since the detachment method is limited.

In the stator unit 18 described above, the cluster block 70 covers the cooling medium paths between the coils W2 and U2 and between the coils V1 and W2 as viewed in the axis C direction while the bottom surface of the cluster block 70 is in contact with the axial end surfaces 42d, 42e of the bobbin 42. Thus, the cooling medium paths between the coils V1, W2, U2 are closed by the cluster block 70.

However, since a part of the tube 59 covering the neutral point 58 is disposed between the bottom surface of the cluster block 70 and the coils V1, W2, the cooling medium paths between the coils U1 to W3 can be inhibited from being further closed by the tube 59. As a result, the cooling medium can easily pass through a lot of the cooling medium paths, so that efficiency of cooling the coils U1 to W3 can be ensured.

The three thick terminal-side lead wires 51 to 53 formed by the nine thin terminal-side lead wires 51a to 53c in total extend from the cluster block 70 in the first direction D1. The two thin terminal-side lead wires 51a, 53a are disposed on the coil U1 below the three terminal-side lead wires 51 to 53. Therefore, the cooling medium path near the first direction D1 side (between the coils U1 and V1) with respect to the cluster block 70 is narrowed by the terminal-side lead wires 51 to 53, 51a, and 53a.

Meanwhile, the five thin terminal-side lead wires 51a, 52a, 53a, 51b, 53b are disposed near the second direction D2 side (between the coils U2 and V2) with respect to the cluster block 70, and the thick terminal-side lead wires 51 to 53 are not disposed. Thus, since the terminal-side lead wires 51 to 53 and 51a to 53c are not densely disposed near the second direction D2 side with respect to the cluster block 70 as compared with near the first direction D1 side, the cooling medium path can be widened near the second direction D2 side.

The end 59a of the closed tube 59 faces in the second direction D2, and is disposed closer to the first direction D1 side than the end portion of the cluster block 70 in the second direction D2. That is, the tube 59 does not protrude toward a portion near the second direction D2 side from the cluster block 70. As a result, the cooling medium path which is widened since the terminal-side lead wires 51 to 53 and 51a to 53c are not densely disposed can be inhibited from being closed by the tube 59, and efficiency of cooling the coils U1 to W3 can be further enhanced.

The terminal-side lead wires 51 to 53 and 51a to 53c, the neutral-point-side lead wires X1 to Z3, and the tube 59 are fixed by winding the threads 60a to 60e (thread 60) on the outer circumferential wall portion 42a. Therefore, on the inner circumferential wall portion 42c side that is the radially opposite side to the side on which the tube 59 and the like are fixed, the cooling medium path is made unlikely to be closed by the tube 59 and the like. That is, the cooling medium path can be widened on the inner circumferential wall portion 42c side, and efficiency of cooling the coils U1 to W3 can be enhanced.

Particularly, the thread 60a presses the tube 59 and the like against the outer circumferential wall portion 42a between the coils U1 to W3 (cooling medium paths). Thus, the cooling medium path on the inner circumferential wall portion 42c side can be further widened, and efficiency of cooling the coils U1 to W3 can be further enhanced. Moreover, the threads 60b to 60e press the tube 59 and the like against the outer circumferential wall portion 42a at the center of each of the coils U1 to W3 in the circumferential direction. Therefore, the tube 59 and the like can be inhibited from expanding inward in the radial direction near the thread 60a. As a result, the cooling medium path on the inner circumferential wall portion 42c side can be made much wider, and efficiency of cooling the coils U1 to W3 can be made much higher.

The tube 59 is implemented by a rolled film, and has predetermined flexibility. Therefore, the tube 59 can be deformed so as to collapse toward the outer circumferential wall portion 42a by the threads 60a to 60e. As a result, the cooling medium path on the inner circumferential wall portion 42c side can be further widened, and efficiency of cooling the coils U1 to W3 can be further enhanced.

The end 59a side portion (compression-bonded portion 59b) of the tube 59 and the cluster block 70 overlap the coil W2 with which one neutral-point-side lead wire Z1 merely overlaps, and the end 59a does not overlap the coil U2 and the like with which the two neutral-point-side lead wires X1 and Z1 or more wires overlap, as viewed in the axis C direction. A space for disposing an object other than the neutral-point-side lead wire Z1 can be widened in a space portion between the bottom surface of the cluster block 70 and the coil W2 at such a portion with which one wire merely overlaps as compared with other portions. Thus, enlargement of the space portion for disposing the tube 59 in the space can be minimized, so that the stator unit 18 (electric motor 30) can be made small.

The terminal-side lead wires 51a, 52a, 53a, 53b, the neutral-point-side lead wires X1, Z1, and the tube 59 are likely to be held in the axis C direction between the cluster block 70 and the coils V1, W2, U2 wound around the bobbin 42. In this case, the cluster block 70 is likely to float from the axial end surface 42d, 42e due to an elastic reaction force of the terminal-side lead wires 51a, 52a, 53a, 53b, the neutral-point-side lead wires X1, Z1, and the tube 59.

However, as described above, the cluster block 70 is made unlikely to be detached from the bobbin 42 by, for example, opposing of the bottom plate 91 and the projection 46, and contact between the regulation surface 91e and the contact surface 42f. That is, the cluster block 70 is made unlikely to float in a state where the cluster block 70 is in contact with the axial end surface 42d, 42e of the bobbin 42. Thus, the cluster block 70 can be inhibited from floating from the bobbin 42 due to, for example, an elastic reaction force of the tube 59, and the size of the stator unit 18 in the axis C direction can be inhibited from being increased due to the floating.

The end 59a side portion of the tube 59 is closed by the flattened compression-bonded portion 59b which is obtained by subjecting the rolled film to thermocompression bonding in the up-down direction. Therefore, a portion other than the end 59a is also entirely made thin in the up-down direction. The upper portion and the lower portion of the tube 59 are aligned in the axis C direction, and the tube 59 is fixed on the coils V1, W2 by the threads 60a to 60e. Thus, the tube 59 can be made unlikely to protrude upward of the axial end surface 42d, 42e of the bobbin 42, and the tube 59 can be made unlikely to come into contact with the bottom surface of the cluster block 70. As a result, the cluster block 70 can be further inhibited from floating from the bobbin 42 due to an elastic reaction force of the tube 59, and the size of the stator unit 18 in the axis C direction can be further inhibited from being increased due to the floating.

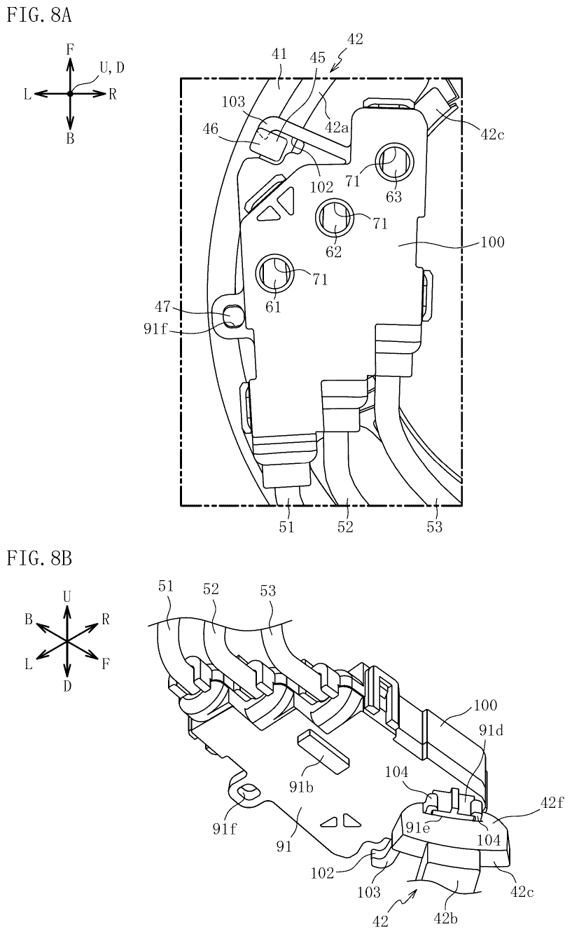

Next, a second embodiment will be described with reference to FIG. 8A and FIG. 8B. In the first embodiment, the first through hole 91a is not opened over the entire periphery. Meanwhile, in the second embodiment, a first through hole 102 is partially opened. The same components as in the first embodiment are denoted by the same reference characters, and the description thereof is omitted. FIG. 8A is a top view of a stator unit having a cluster block 100 according to the second embodiment. FIG. 8B is a perspective view of the cluster block 100.

In the bottom plate 91 of the cluster block 100, the first through hole 102 is formed instead of the first through hole 91a according to the first embodiment. The cluster block 100 and the cluster block 70 of the first embodiment have the same configuration except for the first through hole 102 and a portion around the first through hole 102.

A part of the rear side of the first through hole 102 on the outer side in the radial direction is opened at the edge of the bottom plate 91 on the outer side in the radial direction. Thus, the bottom plate 91 on the front side around the first through hole 102 is formed as a hook portion 103 in which the end of the portion extending outward in the radial direction is curved rearward into a claw-like shape.

When the cluster block 100 is mounted to the bobbin 42, the insertion portion 47 is firstly inserted into the second through hole 91f such that the hook portion 103 is positioned inward of the protrusion 45 in the radial direction, and the lower surface of the bottom plate 91 is brought into contact with the axial end surfaces 42d, 42e of the bobbin 42. Thereafter, the hook portion 103 is rotated around the insertion portion 47 and elastically deformed while the hook portion 103 is pressed against the protrusion 45, and the hook portion 103 is caught by the protrusion 45 below the projection 46. Thus, the cluster block 100 can be easily mounted to the bobbin 42.

The direction in which the hook portion 103 is pressed against the protrusion 45 when the cluster block 100 is mounted is the same as the direction in which a force is applied to the cluster block 100 due to an elastic reaction force of the terminal-side lead wires 51 to 53 relative to the bobbin 42. Therefore, by using the elastic reaction force, the hook portion 103 can be pressed against the protrusion 45 and elastically deformed, and the hook portion 103 can be easily caught by the protrusion 45.

Also in the second embodiment in which the first through hole 102 is opened by the hook portion 103, the cluster block 100 may be mounted to the bobbin 42 in the same method as in the first embodiment. Specifically, after the protrusion 45 and the projection 46 are inserted into the first through hole 102, the wall portion 91d side portion of the bottom plate 91 may be inclined by using the first through hole 102 as a pivot, and the bottom plate 91 may thus be brought into contact with the axial end surface 42e.

A pair of attachment portions 104 to be caught by the wall portion 91d protrude from the contact surface 42f of the bobbin 42 according to the second embodiment. The bobbin 42 of the first embodiment and the bobbin 42 of the second embodiment have the same configuration except that the attachment portions 104 are disposed in the second embodiment.

The pair of attachment portions 104 protrude inward in the radial direction from the contact surface 42f along both sides, in the circumferential direction, of the wall portion 91d in which the regulation surface 91e is brought into contact with the contact surface 42f, and the ends of the attachment portions 104 are formed so as to be curved toward each other into a claw-like shape. The ends of the attachment portions 104 come into contact with the inner surface of the wall portion 91d in the radial direction. By the pair of attachment portions 104, contact between the contact surface 42f and the regulation surface 91e can be more easily maintained, and accuracy for positioning the cluster block 100 relative to the bobbin 42 in the radial direction can be further enhanced.

When the pair of attachment portions 104 are caught by the wall portion 91d, the wall portion 91d is pressed against the pair of attachment portions 104, and the pair of attachment portions 104 are elastically deformed in the direction in which the attachment portions 104 are away from each other. As in the first embodiment, after the protrusion 45 is inserted into the first through hole 102, the wall portion 91d side portion of the bottom plate 91 may be inclined by using the first through hole 102 as a pivot, and the attachment portions 104 may be caught by the wall portion 91d when the bottom plate 91 is brought into contact with the axial end surface 42e. In this case, the number of steps is slightly increased since the wall portion 91d is pressed against the pair of attachment portions 104.

However, in the present embodiment, as described above, after the bottom plate 91 is brought into contact with the axial end surfaces 42d, 42e, the hook portion 103 is rotated around the insertion portion 47, and the hook portion 103 can be caught by the protrusion 45. Therefore, simultaneously with the rotation, the attachment portions 104 can be caught by the wall portion 91d, and thus, the cluster block 100 can be easily mounted to the bobbin 42 without substantially increasing the number of steps even in a case where the attachment portions 104 are disposed.

Although the present invention has been described above with reference to the embodiments, the present invention is not limited to the above-described embodiments in any way. It can be easily understood that various modifications can be devised without departing from the gist of the present invention. For example, the shapes of the components such as the cluster blocks 70, 100, the rotor 31, and the stator 40, or the dimensional relationship therebetween may be changed as appropriate. As the coils U1 to W3, the U-phase, the V-phase, and the W-phase coils may not necessarily be aligned in this order in the second direction D2. The U-phase, the V-phase, and the W-phase coils may be aligned in this order in the first direction D1.

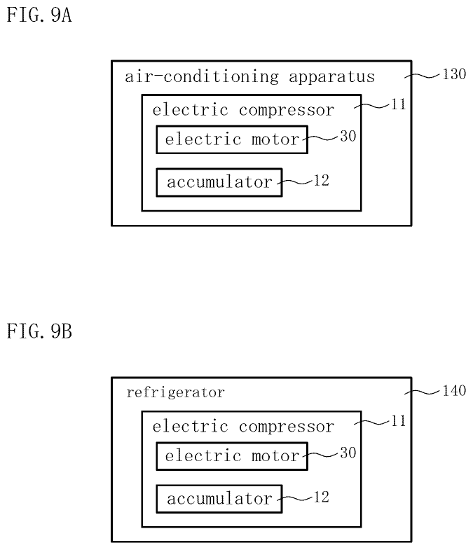

In the above-described embodiments, a case where the electric compressor 11 (electric motor 30) having the cluster block 70, 100 is mounted to the vehicle 1, has been described. However, the present invention is not limited thereto. As shown in FIG. 9A, the electric compressor 11 having the cluster block 70, 100 may be mounted to an air-conditioning apparatus 130 for sending cool air to a room of a building and the like. The air-conditioning apparatus 130 generates cool air by the electric compressor 11 that mainly includes the electric motor 30 and the accumulator 12, similarly to the air-conditioning apparatus 10 described above in the embodiments.

As shown in FIG. 9B, the electric compressor 11 (electric motor 30) having the cluster block 70, 100 may be mounted to a refrigerator 140. The refrigerator 140 generates cool air by the electric compressor 11 that mainly includes the electric motor 30 and the accumulator 12, and cools the inside of the refrigerator by the cool air, similarly to the air-conditioning apparatus 10 described above in the embodiments.

In the above-described embodiments, the terminal-side lead wires 51a to 53c extend from the coils U1 to W3, respectively, in the second direction D2. However, the present invention is not necessarily limited thereto. The terminal-side lead wires 51a to 53c may extend from the coils U1 to W3, respectively, in the first direction D1. Furthermore, the neutral-point-side lead wires X1 to Z3 may extend from the coils U1 to W3, respectively, in the first direction D1. The direction in which the terminal-side lead wires 51a to 53c extend may be different from the direction in which the neutral-point-side lead wires X1 to Z3 extend.

In the above-described embodiments, a part of the tube 59 is disposed between the bottom surface of the cluster block 70, 100 and the coils V1, W2. However, the present invention is not necessarily limited thereto. For example, the entirety of the tube 59 may be disposed between the bottom surface of the cluster block 70, 100 and the coils V1, W2. Moreover, at least a part of the tube 59 may be disposed between the bottom surface of the cluster block 70, 100 and the coils W2, U2. The cluster block 70, 100 may be extended between two or more of the coils U1, W1, V2, U3, V3, W3, and at least a part of the tube 59 may be disposed therebetween.

In the above-described embodiments, the end 59a of the tube 59 is disposed closer to the first direction D1 side than the end portion of the cluster block 70, 100 in the second direction D2. However, the present invention is not necessarily limited thereto. The end 59a of the tube 59 may protrude in the second direction D2 beyond the end portion of the cluster block 70, 100 in the second direction D2. Also in this case, the tube 59 is preferably prevented from protruding above a portion between the coils U2 and V2 near the second direction D2 side with respect to the cluster block 70, 100. Thus, the cooling medium path between the coils U2 and V2 can be inhibited from being closed by the tube 59. However, in a case where at least a part of the tube 59 is disposed below the cluster block 70, 100, the cooling medium path is made unlikely to be closed as compared with a case where the tube 59 is not disposed at all below the cluster block 70, 100, and thus, the tube 59 may protrude above a portion between the coils U2 and V2.

In the above-described embodiments, the terminal-side lead wires 51 to 53 and 51a to 53c, the neutral-point-side lead wires X1 to Z3, and the tube 59 are fixed by winding the threads 60a to 60e on the outer circumferential wall portion 42a. However, the present invention is not necessarily limited thereto. The tube 59 and the like may be fixed by winding the threads on the inner circumferential wall portion 42c. Also in this case, the cooling medium path is made unlikely to be closed by the tube 59 and the like on the outer circumferential wall portion 42a side, and therefore, efficiency of cooling the coils U1 to W3 can be enhanced. The method for winding the threads 60a to 60e is not necessarily limited to the method described above in the embodiments, and may be changed as appropriate.

In the above-described embodiments, the first through hole 91a is displaced rearward in the circumferential direction from the front surface position of the regulation surface 91e. However, the present invention is not limited thereto. For example, the first through hole 91a may be displaced forward in the circumferential direction from the front surface position of the regulation surface 91e. Furthermore, the first through hole 91a may be disposed in front of the regulation surface 91e. In both a case where the first through hole 91a is disposed in front of the regulation surface 91e and a case where the first through hole 91a is displaced from the front surface position of the regulation surface 91e, the regulation surface 91e is defined as facing toward the first through hole 91a.

In the above-described embodiments, the regulation surface 91e of the wall portion 91d faces outward in the radial direction, and the projection 46 projects outward from the protrusion 45 in the radial direction. However, the present invention is not necessarily limited thereto. As long as the direction in which the regulation surface 91e faces and the direction in which the projection 46 projects from the protrusion 45 are the same as viewed in the up-down direction, the directions may be the radially inward direction, the circumferential direction, or the like. The direction in which the regulation surface 91e faces and the direction in which the projection 46 projects from the protrusion 45 are defined as being the same not only in a case where the linear line that is almost perpendicular to the regulation surface 91e, is parallel to the linear line passing through the center of the projection 46 in the width direction (circumferential direction) as viewed in the up-down direction, but also in a case where these linear lines are slightly deviated from the parallel state (for example, at 10°).

The positions of the wall portion 91d, the first through hole 91a, 102, the second through hole 91f, and the like may be changed as appropriate. According to the change, the positions of the contact surface 42f, the protrusion 45, and the insertion portion 47 may be changed. For example, the contact surface 42f may not necessarily be the inner circumferential wall surface of the inner circumferential wall portion 42c, and the contact surface 42f may be the inner circumferential wall surface or the outer circumferential wall surface of the outer circumferential wall portion 42a. When the outer circumferential wall surface of the outer circumferential wall portion 42a is the contact surface 42f, the surface of the wall portion 91d on the inner side in the radial direction is the regulation surface 91e.

In the above-described embodiments, the projection length L1 of the projection 46 is half or more the thickness L2 of the protrusion 45 in the first through hole 91a, and the length of the first through hole 91a in the projecting direction of the projection 46 is larger than the total of the projection length L1 and the thickness L2. However, the dimensional relationship may be changed as appropriate.

### DESCRIPTION OF REFERENCE NUMERALS

10 air-conditioning apparatus (on-vehicle apparatus)
18 stator unit
30 electric motor
40 stator
41 stator core
41a axial end surface (of stator core)
41b yoke portion
41c tooth portion
42 bobbin
42a outer circumferential wall portion
42c inner circumferential wall portion
42d, 42e axial end surface (of bobbin)
42f contact surface
43, U1˜U3 , V1˜V3, W1˜W3 coil
45 protrusion
46 projection
51˜53, 51a˜51c, 52a˜52c, 53a˜53c terminal-side lead wire
58 neutral point
59 tube
59a end (of tube)
60, 60a˜60e thread
61, 62, 63 connection terminal
70, 100 cluster block
91 bottom plate
91a, 102 first through hole
91d wall portion
91e regulation surface
130 air-conditioning apparatus
140 refrigerator
D1 first direction
D2 second direction
X1˜X3 , Y1˜Y3 , Z1˜Z3 neutral-point-side lead wire

What is claimed is:

1. A stator unit comprising:
a cylindrical stator disposed in an electric motor; and
an insulating cluster block coming into contact with an end surface of the stator in an axial direction, wherein
the stator includes
a stator core having a plurality of tooth portions protruding inward from a yoke portion in a radial direction,
an insulating bobbin disposed at an axial end surface of the stator core,
a plurality of coils forming a three-phase coil, the plurality of coils being formed by a conductor wound around the bobbin and the respective tooth portions in a concentrated winding manner, the plurality of coils being aligned in a circumferential direction of the stator,
a plurality of cooling medium paths each formed between the coils in the circumferential direction, and connected to both sides of the stator in the axial direction,
a plurality of terminal-side lead wires each of which is continuous with one end of the conductor forming a corresponding one of the coils and is extracted from the corresponding one of the coils,
a plurality of neutral-point-side lead wires each of which is continuous with another end of the conductor forming a corresponding one of the coils and is extracted from the corresponding one of the coils, the plurality of neutral-point-side lead wires being connected to each other to form a neutral point, and
an insulating tube for covering the neutral point, the insulating tube having a tubular bag-like shape in which an end is closed,
the cluster block is an insulating box-like member for storing a three-phase connection terminal disposed at an end of the plurality of terminal-side lead wires,
a bottom surface of the cluster block comes into contact with an axial end surface of the bobbin on an opposite side to the stator core side so as to cover at least one of the cooling medium paths as viewed in the axial direction, and
at least a part of the tube is disposed between the bottom surface of the cluster block and the coils so as to overlap therewith as viewed in the axial direction.

2. The stator unit according to claim 1, wherein
in the circumferential direction, a direction in which the terminal-side lead wires exit from the cluster block is a first direction, and a direction opposite to the first direction is a second direction, and
an end of the closed tube faces in the second direction, and is disposed closer to the first direction side than an end portion of the cluster block in the second direction.

3. The stator unit according to claim 1, wherein
the bobbin includes
an outer circumferential wall portion disposed along an outer side of each coil in the radial direction, the outer circumferential wall portion protruding toward an opposite side to the stator core side with respect to the coil, and
an inner circumferential wall portion disposed along an inner side of each coil in the radial direction, the inner circumferential wall portion protruding toward the opposite side to the stator core side with respect to the coil, and
the plurality of terminal-side lead wires, the plurality of neutral-point-side lead wires, and the tube are fixed by winding a thread on either one of the outer circumferential wall portion and the inner circumferential wall portion.

4. The stator unit according to claim 3, wherein
in the circumferential direction, a direction in which an end of the tube faces is a second direction,
the plurality of neutral-point-side lead wires extend from the coils, respectively, in the second direction and gradually merge, and
an end side portion of the tube and the cluster block overlap the coil with which one of the neutral-point-side lead wires merely overlaps as viewed in the axial direction.

5. The stator unit according to claim 1, wherein
the cluster block includes
a bottom plate having the bottom surface,
a first through hole penetrating through the bottom plate in the axial direction, and
a wall portion having a regulation surface facing toward the first through hole, the wall portion extending toward the stator core from the bottom surface,
the bobbin includes
a protrusion protruding from the axial end surface of the bobbin, the protrusion being inserted into the first through hole,
a projection projecting from an end of the protrusion in a direction that is the same as a direction in which the regulation surface faces, and
a contact surface coming into contact with the regulation surface, and
a part of the bottom plate around the first through hole and the projection oppose each other in the axial direction in a state where the contact surface is in contact with the regulation surface.

6. An electric motor comprising the stator unit according to claim 1.

7. An air-conditioning apparatus comprising the electric motor according to claim 6.

8. A refrigerator comprising the electric motor according to claim 6.

9. An on-vehicle apparatus comprising the electric motor according to claim 6.
